(19) United States
(12) Patent Application Publication
(10) Pub. No.: US 2020/0043495 A1
(43) Pub. Date: Feb. 6, 2020

(54) METHOD AND APPARATUS FOR PERFORMING MULTI-LANGUAGE COMMUNICATION

(71) Applicant: LG ELECTRONICS INC., Seoul (KR)

(72) Inventors: Yongchul PARK, Seoul (KR); Minook KIM, Seoul (KR); Sang Ki KIM, Seoul (KR); Siyoung YANG, Seoul (KR); Juyeong JANG, Seoul (KR); Sungmin HAN, Seoul (KR)

(21) Appl. No.: 16/601,787

(22) Filed: Oct. 15, 2019

(30) Foreign Application Priority Data
Sep. 20, 2019 (KR) 10-2019-0116406

(51) Int. Cl. G10L 15/22; G10L 13/04; G10L 15/00; G10L 15/26; G10L 15/25

(52) U.S. Cl. CPC G10L 15/22; G10L 13/043; G10L 15/25; G10L 15/265; G10L 15/005

(57) ABSTRACT

A method for performing multi-language communication includes receiving an utterance, identifying a language of the received utterance, determining whether the identified language matches a preset reference language, applying, to the received utterance, an interpretation model interpreting the identified language into the reference language when the identified language does not match the reference language, changing, to text, speech data which is outputted in the reference language as a result of applying the interpretation model, generating a response message responding to the text of the speech data, and outputting the response message. Here, the interpretation model may be a deep neural network model generated through machine learning, and the interpretation model may be stored in an edge device or provided through a server in an Internet of things environment through a 5G network.

### CROSS-REFERENCE TO RELATED APPLICATION

This application claims benefit of priority to Korean Patent Application No. 10-2019-0116406, filed on Sep. 20, 2019, the entire disclosure of which is incorporated herein by reference.

### BACKGROUND

### 1. Technical Field

The present disclosure relates to a method and apparatus for performing multi-language communication. More specifically, the present disclosure relates to a method and apparatus for performing multi-language communication for presetting a reference language as a reference for speech processing, identifying a language of an inputted utterance, changing the identified language to the reference language, and then performing speech processing.

### 2. Description of Related Art

With the development of technology, various services applying speech recognition technology are being introduced in many fields. Speech recognition technology is a technology that enables a machine device to understand speech uttered by a person and thereby provide a service desired by the person, which accordingly enables smooth interaction between a user and the machine device.

In connection with speech recognition, since various languages are used for communication in actual use environments, it is necessary to recognize various languages in order to utilize speech recognition technology.

In this regard, in U.S. Patent Application Publication No. 2018-0240456, entitled “Method for controlling artificial intelligence system that performs multilingual processing”, disclosed is a method for receiving speech information, determining a language of the received speech information, selecting a specific speech recognition server from a plurality of speech recognition servers processing different languages using a language determination result, and transmitting speech information to the specific speech recognition server.

In this method, a separate server needs to be prepared for each language, and there is a need to secure a connection with these servers in order to perform speech recognition.

However, natural language processing through speech recognition requires considerable processing capability even when limited to one language, and there is a difficulty in that a separate model for natural language processing is required for each language.

Nonetheless, with increasing international exchange and the development of world trade, the need for a speech recognition device supporting various languages continues to increase.

Accordingly, there is a need for a new solution that can reduce program development resources and processing resources while enabling multilingual speech recognition.

Meanwhile, the above-described background art is technical information retained by the inventor to derive the present disclosure or acquired by the inventor while deriving the present disclosure, and thus should not be construed as art that was publicly known prior to the filing date of the present disclosure.

### SUMMARY OF THE INVENTION

An aspect of the present disclosure is to address a shortcoming associated with some related art in which considerable processing resources and program development resources should be inputted in order to enable multilingual speech recognition.

In addition, another aspect of the present disclosure is to address a shortcoming associated with some related art in which speech recognizers for each language, natural language processing modules for each language, and speech synthesizers for each language should be provided in order to enable multilingual speech recognition.

In addition, another aspect of the present disclosure is to address a shortcoming associated with some related art in which, in order to enable multilingual speech recognition, processing modules and algorithms are needed for each language, which requires a complicated development process and considerable resources and time for development.

In addition, another aspect of the present disclosure is to address a shortcoming associated with some related art in which it is difficult to appropriately select speech processors for each language for multilingual speech recognition, and each selected speech processor requires high processing resources for speech processing of the language.

An embodiment of the present disclosure may provide a multilingual speech recognition apparatus and method capable of changing inputted speech to speech in one reference language based on machine interpretation, and processing the speech changed to the reference language using a speech recognizer, a natural language processing module, and a speech synthesizer which are configured to process the reference language.

Another embodiment of the present disclosure may provide a multilingual speech recognition apparatus and method capable of setting a reference language based on a language frequently used at a location where a speech recognition service is provided, so that the frequently used language may be the reference language in speech recognition.

Another embodiment of the present disclosure may provide a multilingual speech recognition apparatus and method capable of forming a candidate group of languages used by an utterer through image analysis of the utterer, comparing a received spoken utterance with the candidate group of languages to identify the language of the received spoken utterance, and performing a speech recognition service appropriate for the corresponding language.

According to an embodiment of the present disclosure, a method for performing multi-language communication may include receiving an utterance, identifying a language of the received utterance, determining whether the identified language matches a preset reference language, applying, to the received utterance, a first interpretation model interpreting the identified language into the reference language when the identified language does not match the reference language, changing, to text, first speech data which is outputted in the reference language as a result of applying the first interpretation model, generating a response message responding to the text of the first speech data, and outputting the response message.

The generating of the response message may include generating, in the reference language, text of the response message responding to the text of the first speech data, and generating second speech data corresponding to the text of the response message.

The outputting of the response message may include applying, to the second speech data, a second interpretation model interpreting the reference language into the identified language, and outputting third speech data, which is outputted in the identified language as a result of applying the second interpretation model.

The first interpretation model may be a neural network model which is trained using training data including, as a label, speech data uttered in the identified language and speech data uttered in the reference language corresponding to the speech data uttered in the identified language.

The second interpretation model may be a neural network model which is trained using training data including, as a label, speech data uttered in the reference language and speech data uttered in the identified language corresponding to the speech data uttered in the reference language.

The changing of the first speech data to text may include converting the first speech data into text using a speech to text (STT) algorithm for the reference language, and the generating of the second speech data may include converting the text of the response message into the second speech data using a text to speech (TTS) algorithm for the reference language.

Prior to the receiving of the utterance described above, the method for performing multi-language communication according to another embodiment of the present disclosure may further include acquiring information on a location where the utterance is to be received, receiving demographic information of an area corresponding to the location information, and determining a most used language based on the demographic information.

After the determining of the most used language, the method for performing multi-language communication according to another embodiment of the present disclosure may further include determining whether the most used language exists in a group of adoptable reference languages, and setting the most used language as the reference language when the most used language exists in the group of adoptable reference languages, and setting, as the reference language, a language belonging to the same language family as the most used language among the languages existing in the group of adoptable reference languages when the most used language does not exist in the group of adoptable reference languages.

The method for performing multi-language communication according to another embodiment of the present disclosure may further include photographing an utterer of the utterance, and the identifying of the language of the received utterance may include determining candidate languages used by the utterer based on an image analysis of the utterer, analyzing the language of the received utterance based on the candidate languages, and determining the language of the received utterance based on the analysis.

In the method for performing multi-language communication according to another embodiment of the present disclosure, the outputting of the response message may include determining a voice to transmit the response message according to a gender or an age of the utterer obtained by the image analysis of the utterer, and outputting the response message in the determined voice.

According to an embodiment of the present disclosure, an apparatus configured to perform multi-language communication may include a microphone configured to receive an utterance, a memory configured to store an instruction, and one or more processors configured to be connected to the microphone and the memory, in which the one or more processors may be configured to identify a language of the utterance received from the microphone, determine whether the identified language matches a preset reference language, apply, to the received utterance, a first interpretation model interpreting the identified language into the reference language when the identified language does not match the reference language, change, to text, first speech data which is outputted in the reference language as a result of applying the first interpretation model, and generate a response message responding to the text of the first speech data.

The one or more processors may be further configured to generate, in the reference language, text of the response message responding to the text of the first speech data, and generate second speech data corresponding to the text of the response message.

The one or more processors may be further configured to apply, to the second speech data, a second interpretation model interpreting the reference language into the identified language, and output third speech data, which is outputted in the identified language as a result of applying the second interpretation model.

The memory may be configured to store the first interpretation model and the second interpretation model, the first interpretation model may be a neural network model which is trained using training data including, as a label, speech data uttered in the identified language and speech data uttered in the reference language corresponding to the speech data uttered in the identified language, and the second interpretation model may be a neural network model which is trained using training data including, as a label, speech data uttered in the reference language and speech data uttered in the identified language corresponding to the speech data uttered in the reference language.

In the apparatus for performing multi-language communication according to another embodiment of the present disclosure, the one or more processors may be further configured to acquire information on a location where the apparatus is installed, receive demographic information of an area corresponding to the location information, and determine a most used language based on the demographic information.

After determining the most used language, the one or more processors may be further configured to determine whether the most used language exists in a group of adoptable reference languages, and set the most used language as the reference language when the most used language exists in the group of adoptable reference languages, and set, as the reference language, a language belonging to the same language family as the most used language among the languages existing in the group of adoptable reference languages when the most used language does not exist in the group of adoptable reference languages.

The apparatus for performing multi-language communication according to another embodiment of the present disclosure may further include a camera configured to photograph an utterer of the utterance, and the one or more processors may be configured to determine candidate languages used by the utterer based on an image analysis of the utterer photographed by the camera, analyze the language of the received utterance based on the candidate languages, and determine the language of the received utterance based on the analysis.

The one or more processors may be configured to determine a voice to transmit the response message according to a gender or an age of the utterer obtained by the image analysis of the utterer photographed by the camera, and output the response message in the determined voice.

According to still another embodiment of the present disclosure, in a computer readable recording medium storing a computer program for performing multi-language communication, the computer program is configured to, when executed by a processor, cause the processor to receive an utterance, identify a language of the received utterance, determine whether the identified language matches a preset reference language, apply, to the received utterance, a first interpretation model interpreting the identified language into the reference language when the identified language does not match the reference language, change, to text, first speech data which is outputted in the reference language as a result of applying the first interpretation model, and generate a response message responding to the text of the first speech data.

Other aspects, features, and advantages in addition to those above-described will become apparent from the following drawings, claims, and detailed description of the disclosure.

Embodiments of the present disclosure can provide the apparatus and method for performing multi-language communication capable of minimizing the input of the required processing resources and program development resources, while enabling multilingual speech recognition.

In addition, the embodiments of the present disclosure can provide an apparatus and method for performing multi-language communication capable of enabling multilingual speech recognition while using a speech recognizer, a natural language processing module, and a speech synthesizer of one language by using machine interpretation.

In addition, the embodiments of the present disclosure can provide an apparatus and method for performing multi-language communication capable of enabling multilingual speech recognition without developing processing modules and algorithms for each language for multiple languages, which requires a complicated development process and considerable resources and time for development.

In addition, the embodiments of the present disclosure can efficiently and effectively perform multilingual language processing in actual use, by predicting the main language to be inputted to an apparatus for performing multi-language communication and setting the reference language as the main language.

In addition, the embodiments of the present disclosure can efficiently and effectively perform multilingual language processing by more accurately identifying the language inputted to the apparatus for performing multi-language communication according to the characteristics of the utterer.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram showing an example of an environment in which an apparatus for performing multi-language communication according to an embodiment of the present disclosure is used;

FIG. 2 is a diagram illustrating a case in which the apparatus for performing multi-language communication according to an embodiment of the present disclosure is used indoors;

FIG. 3 is a diagram showing an example of an environment in which a user terminal for performing multi-language communication according to an embodiment of the present disclosure is used;

FIG. 4 is a diagram showing a system for creating a neural network model for multilingual speech interpretation according to an embodiment of the present disclosure;

FIG. 5 is a block diagram of the apparatus for performing multi-language communication according to an embodiment of the present disclosure;

FIG. 6 is a diagram for describing an apparatus requiring speech processing modules for each language;

FIG. 7 is a diagram for describing the apparatus for performing multi-language communication according to an embodiment of the present disclosure;

FIG. 8 is a diagram for describing a process of generating a neural network model for multilingual speech interpretation according to an embodiment of the present disclosure;

FIG. 9 is a diagram for describing a process of applying a neural network model created for multilingual speech interpretation according to an embodiment of the present disclosure;

FIG. 10 is a diagram for describing the neural network model created for multilingual speech interpretation according to the embodiment of the present disclosure; and

FIG. 11 is a flowchart of a method for performing multi-language communication according to an embodiment of the present disclosure.

### DETAILED DESCRIPTION

The advantages and features of the present disclosure and ways to achieve them will be apparent by making reference to embodiments as described below in detail in conjunction with the accompanying drawings. However, it should be construed that the present disclosure is not limited to the embodiments disclosed below but may be implemented in various different forms, and covers all the modifications, equivalents, and substitutions belonging to the spirit and technical scope of the present disclosure. The embodiments disclosed below are provided so that this disclosure will be thorough and complete and will fully convey the scope of the present disclosure to those skilled in the art. Further, in the following description of the present disclosure, a detailed description of known technologies incorporated herein will be omitted when it may make the subject matter of the present disclosure rather unclear.

The terms used in this application is for the purpose of describing particular embodiments only and is not intended to limit the disclosure. As used herein, the singular forms are intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, embodiments of the present disclosure will be described in detail with reference to the accompanying drawings, and in the description with reference to the accompanying drawings, the same or corresponding components have the same reference numeral, and a duplicate description therefor will be omitted.

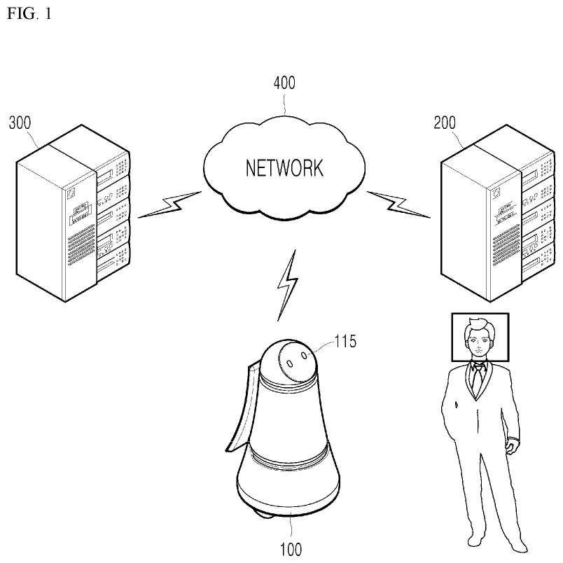

FIG. 1 is a diagram showing an example of an environment in which an apparatus for performing multi-language communication according to an embodiment of the present disclosure is used.

As shown in FIG. 1, an apparatus 100 for performing multi-language communication may be a movable robot. The apparatus 100 for performing multi-language communication may include a sensor 150, and may interact with a user through the sensor 150. The sensor 150 may include a camera and a microphone, and the apparatus 100 for performing multi-language communication may recognize a user through the camera and receive a voice instruction from the user through the microphone.

In the process of performing speech processing, the apparatus 100 for performing multi-language communication may communicate with external servers 200 and 300 through the network 400. The external servers 200 and 300 may be a server computing system 200 capable of performing natural language processing or a training computing system 300 capable of creating a neural network model for language processing.

The apparatus 100 for performing multi-language communication implemented as a robot may communicate with a user while moving an indoor space. The apparatus 100 for performing multi-language communication can communicate with a user in various languages through the communication with the external servers 200 and 300.

Meanwhile, in FIG. 1, although the apparatus 100 for performing multi-language communication is implemented as the robot, it may be implemented in various electronic devices such as an artificial intelligence speaker, a smartphone, a tablet, and a computer.

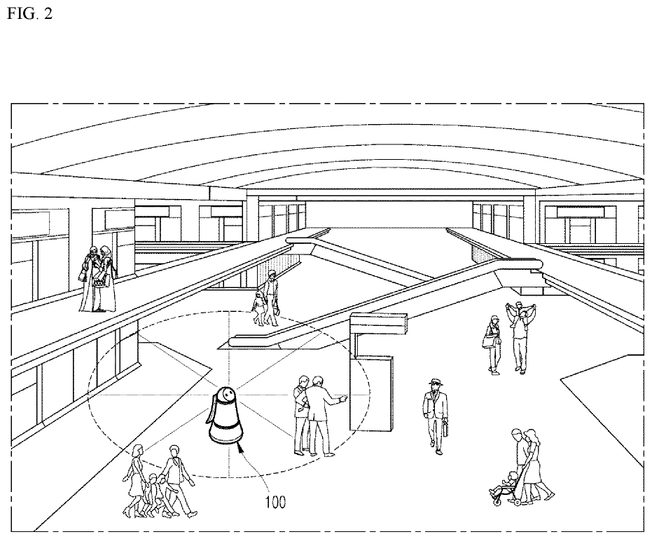

FIG. 2 is a diagram illustrating a case in which the apparatus for performing multi-language communication according to an embodiment of the present disclosure is used indoors.

For example, the apparatus 100 for performing multi-language communication implemented as the robot may be used in an airport. People of various nationalities gather at the airport, and airport passengers need various information when using the airport.

For the airport passengers, a robot for enabling multi-language communication may be arranged at the airport, and speech interaction may be started as the airport passengers approach the robot or the robot searches the surroundings and approaches airport passengers who need assistance.

The robot equipped with the apparatus 100 for performing multi-language communication according to this embodiment of the present disclosure disposed at the airport has an ability to communicate in various languages. The robot according to this embodiment of the present disclosure may include a speech recognizer, a natural language processor, and a speech synthesizer capable of processing an utterance of a reference language, which is one language, but may perform multi-language communication using machine interpretation.

Each airport passenger transmits voice instructions to the robot in his or her own language. In order for the robot to process a voice instruction transmitted to the robot, the robot should first determine in what language the voice instruction is uttered.

If the language of the voice instruction transmitted to the robot is determined, the robot may use a machine interpreter to convert the language into a reference language, perform speech recognition and natural language processing using the reference language, and generate a response message written in the reference language. The response message written in the reference language may then be translated into the user's language using the machine interpreter.

In this manner, the robot equipped with the speech recognizer, the natural language processor, and the speech synthesizer capable of processing the utterance of the reference language, which is one language, may perform multi-language communication.

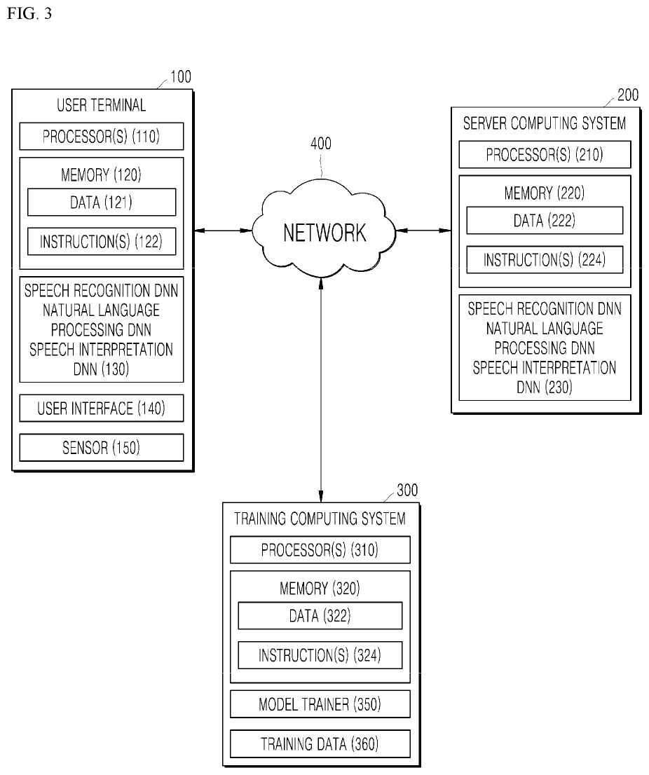

FIG. 3 is a diagram showing an example of an environment in which a user terminal for performing multi-language communication according to an embodiment of the present disclosure is used.

The environment for performing multi-language communication according to this embodiment of the present disclosure may include a user terminal 100, the server computing system 200, the training computing system 300, and a network 400 that enables the user terminal 100, the server computing system 200, and the training computing system 300 to communicate with each other. Here, the user terminal 100 may be the apparatus for performing multi-language communication.

The user terminal 100 may support various kinds of object-to-object intelligent communication (such as Internet of things (IoT), Internet of everything (IoE), and Internet of small things (IoST)), and may support communication such as machine to machine (M2M) communication and device to device (D2D) communication.

The user terminal 100 may determine a method for improving image resolution using big data, artificial intelligence (AI) algorithms, and/or machine learning algorithms in a 5G environment connected for the Internet of things (IoT).

The user terminal 100 may be, for example, any kind of computing device, such as a personal computer, a smartphone, a tablet, a game console, and a wearable device. The user terminal 100 may include one or more processors 110 and a memory 120.

The one or more processors 110 may include any type of device capable of processing data, such as an MCU. Here, the ‘processor’ may refer to a data processing apparatus embedded in hardware having, for example, a circuit physically structured to perform a function represented by codes or instructions included in a program.

As an example of a data processing device embedded in hardware, processing devices such as a microprocessor, a central processing unit (CPU), a processor core, a multiprocessor, an application-specific integrated circuit (ASIC), and a field programmable gate array (FPGA) may be used, but the scope of the present disclosure is not limited thereto.

The memory 120 may include one or more non-transitory storage media such as RAM, ROM, EEPROM, EPROM, flash memory devices, and magnetic disks. The memory 120 may store instructions 124 that cause the user terminal 100 to perform operations when executed by data 122 and processors 110.

In addition, the user terminal 100 may include a user interface 140 to receive instructions from a user and to transmit output information to the user. The user interface 140 may include various input means such as a keyboard, a mouse, a touch screen, a microphone, and a camera, and various output means such as a monitor, a speaker, and a display.

The sensor 150 of the user terminal 100 is a means for receiving external information, and the sensor 150 may include a microphone and a camera. The user terminal 100 may receive a voice instruction from a user or an utterer through the microphone, and may photograph an image of the user or the utterer through the camera.

In one embodiment, the user terminal 100 may also store or include speech processing neural network models 130 to which artificial intelligence technology is applied. For example, the speech processing neural network models 130 to which the artificial intelligence technology is applied may include a deep neural network model for speech recognition, a natural language processing deep neural network model, and a speech interpretation deep neural network model. In addition, the speech processing neural network models 130 may be or may include various learning models such as deep neural networks or other types of machine learning models.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the Artificial Neural Network can include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

In the meantime, a deep neural network with a plurality of hidden layers between the input layer and the output layer may be the most representative type of artificial neural network which enables deep learning, which is one machine learning technique.

An ANN can be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

The speech processing neural network models 130 to which the artificial intelligence technology as described above is applied may be first created via a training step by the training computing system 300, and may be stored in the server computing system 200 or transmitted to the user terminal 100 through the network 400.

The speech processing neural network models 130 may include neural network models for speech recognition, natural language processing, and speech interpretation, the speech recognition neural network model may be a learning model trained to convert speech into text, and the natural language processing neural network model may be a learning model which is trained to analyze text to grasp meaning and generate responses according to the meaning. The speech interpretation neural network model may be a learning model trained to convert speech of various languages into speech of a reference language.

Typically, the speech processing neural network models 130 may be stored in the user terminal 100 in a state that can be applied after being subjected to the training step in the training computing system 300, but in some embodiments, the speech processing neural network models 130 may be updated or upgraded through additional training in the user terminal 100.

Meanwhile, the speech processing neural network models 130 stored in the user terminal 100 may be some of the speech processing neural network models 130 generated by the training computing system 300, and if necessary, new speech processing neural network models may be created by the training computing system 300 and transmitted to the user terminal 100.

As another example, the speech processing neural network models 130 may be stored in the server computing system 200 instead of being stored in the user terminal 100, and may provide necessary functions to the user terminal 100 in the form of a web service.

The server computing system 200 may include processors 210 and a memory 220, and may generally have greater processing capability and larger memory capacity than the user terminal 100. Accordingly, according to the system implementation, heavy speech processing neural network models 230 that require greater processing capability for the application may be configured to be stored in the server computing system 200, and lightweight speech processing neural network models that require less processing capability for the application may be configured to be stored in the user terminal 100.

The speech processing neural network models 130 and 230 included in the user terminal 100 or the server computing system 200 may be the neural network models created by the training computing system 300.

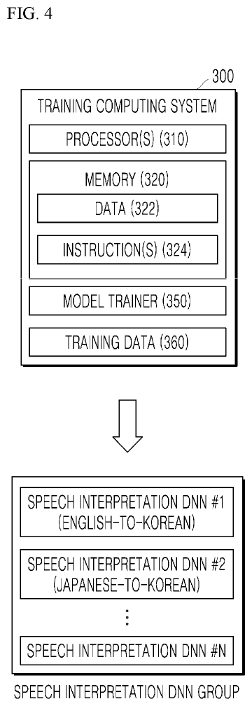

FIG. 4 is a diagram showing a system for creating a neural network model for multilingual speech interpretation according to an embodiment of the present disclosure.

The training computing system 300 may include one or more processors 310 and a memory 320. In addition, the training computing system 300 may include a model trainer 350 and training data 360 for training machine learning models.

The training computing system 300 may create a plurality of speech processing neural network models based on the training data 360 through the model trainer 350.

If the training data 360 are a data set that includes Korean text and Korean speech data of the text as a label, the training computing system 300 may create a text-to-speech conversion neural network model capable of converting the Korean text into Korean speech.

In addition, if the training data 360 are a data set that includes Korean speech data and Korean text of the speech as a label, the training computing system 300 may create a speech-to-text conversion neural network model capable of converting the Korean speech into Korean text.

Meanwhile, if the training data 360 are a data set that includes English speech data and Korean speech data of the corresponding English speech as a label, the training computing system 300 may create an English-to-Korean interpretation neural network model capable of converting English speech into Korean speech.

In addition, if the training data 360 are a data set that includes Korean speech data and English speech data of the corresponding Korean speech as a label, the training computing system 300 may create a Korean-to-English interpretation neural network model capable of converting Korean speech into English speech.

Here, the speech-to-text conversion neural network model, the text-to-speech conversion neural network model, and the interpretation neural network model may be learning models created by training neural network models initially designed with different structures.

In addition, the training computing system 300 may perform training in the same manner for various languages, and create a neural network model capable of performing the interpretation or the text and speech conversion between various languages.

In the same manner as described above, the training computing system 300 may create a speech interpretation deep neural network group of various languages. The speech interpretation deep neural network group may include deep neural network models for interpretation between specific languages, such as a deep neural network model for English-to-Korean interpretation and a deep neural network model for Japanese-Korean interpretation.

Here, the structural characteristics of the deep neural network models are determined by the number of input nodes, the number of features, the number of channels, the number of hidden layers and the like, and it can be understood that the larger the number of features, the larger the number of channels, and the larger the number of hidden layers, the higher the complexity. In addition, it may be said that the larger the number of channels and the larger the number of hidden layers, the heavier the neural network. In addition, the complexity of the neural network may be referred to as the dimensionality of the neural network.

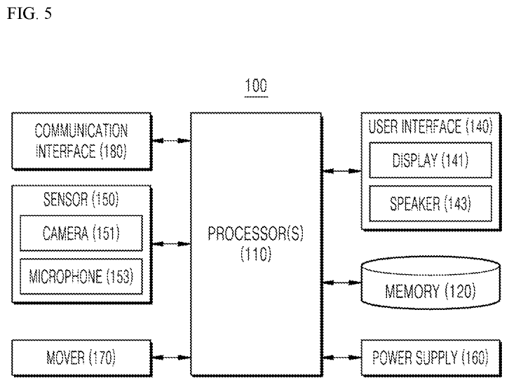

FIG. 5 is a block diagram of the apparatus for performing multi-language communication according to an embodiment of the present disclosure.

The apparatus 100 for performing multi-language communication may include one or more processors 110, a memory 120, a user interface 140, a sensor 150, a power supply 160, a mover 170, and a communication interface 180.

The processors 110 may perform various data processing operations according to instructions stored in the memory 120, and may communicate with various components of the apparatus 100 for performing multi-language communication.

The memory 120 may store instructions executed by a processor and may store neural network models and various algorithms described above.

The user interface 140 may include a display 141 and a speaker 143, may display various types of information as an image through the display 141, and may output various types of information as speech through the speaker 143.

The sensor 150 may include a camera 151 and a microphone 153, the camera 151 may photograph images of, for example, the surrounding environment and an utterer, and the microphone 153 may collect the surrounding noise and the speech of the utterer.

The camera 151 may assist the apparatus 100 for performing multi-language communication in identifying the language of a received utterance. In addition to speech analysis, candidate languages predicted to be used by the utterer may be selected based on the utterer's image photographed by the camera 151.

For example, if an utterer's ethnicity is determined to be Indian based on the image analysis of the utterer, candidate languages predicted to be used by the utterer may be determined to be English and Hindi. The determination of such candidate languages may be preset by ethnicity.

In another embodiment, the apparatus 100 for performing multi-language communication may create a candidate language determination model by using the image analysis of the utterer based on the photographed image of the utterer and the identified speech data while performing the multi-language communication.

As described above, if the processor of the apparatus 100 for performing multi-language communication has defined the utterer's candidate languages as English and Hindi, the processor may be configured to analyze whether the language of the received utterance is English or Hindi, and determine the language of the received utterance based on the analysis. Accordingly, the language identification can be made more accurately and efficiently.

In addition, the image of the utterer photographed by the camera 151 may be used even in the process of outputting a response message. For example, when the response message is outputted, a voice that is outputted may be determined according to a gender or an age of the utterer, obtained by analyzing the image of the utterer.

The processor of the apparatus 100 for performing multi-language communication may be configured to analyze the photographed image of the utterer, and to set the speed of the outputted voice to be slower if the utterer is elderly or young, or generate a male voice if the utterer is a male and a female voice if the utterer is female.

The power supply 160 performs a function of supplying power so that the apparatus 100 for performing multi-language communication can operate. The power supply 160 may supply power from its own battery, or by being connected to an external power source.

The mover 170 may perform a function of moving the apparatus 100 for performing multi-language communication or the equipment in which the apparatus 100 for performing multi-language communication is installed.

A computer program for performing multi-language communication according to an embodiment of the present disclosure may be executed by the processors 110. The computer program may cause the processor to receive an utterance uttered by a user or an utterer, identify the language of the received utterance, and determine whether the identified language matches a preset reference language.

Here, the reference language may be a preset language, and may be previously determined in consideration of the environment in which the apparatus for performing multi-language communication is used. For example, if the apparatus for performing multi-language communication is used in an airport in the United Kingdom, the reference language may be set to English, since English is most likely to be the most used language.

Various methods for identifying the language of the received utterance exist, for example, Apache OpenNLP, Apache Tika, and the like may be used. Other machine learning-based programs may be used to identify the language of the received utterance.

If the identified language does not match the preset reference language, the processor may apply, to the received utterance, a first interpretation model that interprets the identified language into the reference language. The first interpretation model may be a neural network model using neural network machine interpretation technology. The first interpretation model may be one of models that are pre-trained to interpret various languages into reference languages. In particular, the first interpretation model may be a deep neural network model that is pre-trained to interpret the identified language into the reference language. For example, if the language of the received utterance is Korean, the first interpretation model may be a deep neural network model for Korean-to-English interpretation.

The processor may output first speech data in a reference language as a result of the application of the first interpretation model. When the reference language is English, the first speech data may be speech data in English corresponding to the received utterance.

If the identified language matches the preset reference language, the processor may skip the step of applying the interpretation model, and may immediately convert the speech data of the received utterance to text.

For example, the first speech data in English, which is the reference language, may be changed into English text through a speech to text (STT) algorithm.

The processor may analyze the meaning of the instruction by performing natural language processing on the utterer's instruction that has been changed into text, and may generate a response message responding to the text of the first speech data.

For example, if an utterer's voice instruction is “Where should I check in large baggage?”, the processor can convert the voice instruction to text, understand its meaning through natural language processing, and generate a response of “Large baggage check-in is on the right side of gate H.”

For example, the above-described response may be generated in English text, which is the reference language. The response generated in text may be converted into an English response voice message through a text to speech (TTS) algorithm for English.

In the example described above, if the utterer is a Korean user, the English response voice message needs to be converted into a Korean response voice message. To this end, an English-to-Korean interpretation deep neural network model can be used.

The processor may employ a suitable interpretation deep neural network model according to the identified uttered language, and convert the response voice message, which is generated by the reference language, into the response voice message generated in the language of the utterer.

Through the above-described process, the apparatus 100 for performing multi-language communication can become able to interact with a user in various languages, even with a speech processor of one language.

Meanwhile, the apparatus 100 for performing multi-language communication can obtain information about the location where the apparatus is installed using, for example, GPS. In addition, the apparatus 100 for performing multi-language communication may receive demographic information of an area corresponding to a corresponding location by communicating with an external server through the communication interface 180.

For example, if the apparatus 100 for performing multi-language communication is installed in Koreatown in LA, the apparatus 100 for performing multi-language communication may receive demographic information of Koreatown in LA, and may obtain information indicating that there are many Korean speakers.

Based on this information, the processor of the apparatus 100 for performing multi-language communication may determine a language which is mostly used in the area. If the language mostly used in the area is Korean, the processor of the apparatus 100 for performing multi-language communication may set Korean as the reference language, and the speech recognizer, the natural language processing module, and the speech synthesizer for Korean in the apparatus 100 for performing multi-language communication may be set to be operated.

In some embodiments, the speech recognizer, the natural language processing module, and the speech synthesizer may correspond to one or more processors. Another embodiment, the speech recognizer, the natural language processing module, and the speech synthesizer may correspond to software components configured to be executed by one or more processors.

Meanwhile, there may be a case where the reference language which can be used by the apparatus 100 for performing multi-language communication is limited. For exemplary purposes, a case may be assumed in which the apparatus 100 for performing multi-language communication is installed in Mongolia, and while English-to-Korean and Korean-to-English interpretation models exist in the interpretation neural network models usable by the apparatus 100 for performing multi-language communication, English-to-Mongolian and Mongolia-to-English interpretation models are not prepared.

In this case, the processor of the apparatus 100 for performing multi-language communication may determine that Mongolian is the most used language in the area based on the demographic information. The processor of the apparatus 100 for performing multi-language communication may determine whether Mongolian is selectable from a group of pre-prepared reference languages.

The apparatus 100 for performing multi-language communication does not have an interpretation model in Mongolian, so it may be determined that Mongolian is not selectable. It may be determined whether a specific language is adaptable as a reference language based on whether an interpretation model using the language exists.

If the processor of the apparatus 100 for performing multi-language communication determines that Mongolian does not exist in the group of adoptable reference languages, as an alternative, a language belonging to the same language family as Mongolian, which is the most used language, may be adopted as the reference language.

Mongolian belongs to the Altaic language family, and Korean is also in the Altaic language family. Since there is an interpretation model using Korean, the processor of the apparatus 100 for performing multi-language communication may set Korean as the reference language instead of Mongolian.

The setting of the reference language as described above may be made before the situation of receiving the utterance, or before the apparatus 100 for performing multi-language communication is placed in the use environment.

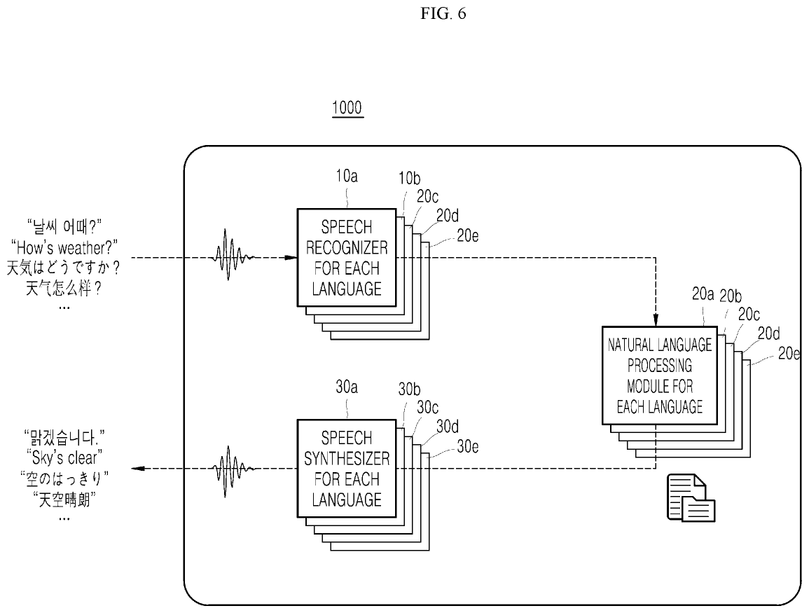

FIG. 6 is a diagram for describing an apparatus requiring speech processing modules for each language.

A multilingual processing apparatus 1000 illustrated in FIG. 6 includes speech recognizers 10a, 10b, 10c, 10d, and 10e for each language, natural language processing modules 20a, 20b, 20c, 20d, and 20e for each language, and speech synthesizers 30a, 30b, 30c, 30d, and 30e for each language.

For example, if speech of “How's the weather? (Nalssiga eottae?)” in Korean is inputted to the multilingual processing apparatus 1000, the multilingual processing apparatus 1000 analyzes the inputted voice, identifies the used language as Korean, and converts the speech of “How's the weather?” into text using the speech recognizer 10a for Korean.

The meaning of “How's the weather?” that has been converted into text is analyzed by the natural language processing module 20a for Korean, the meaning thereof is understood as a question about the weather, and the sentence “It's fine (Makgetseumnida)” in Korean is generated as text in response to the question.

The text of “It's fine” in Korean is converted into speech data of “It's fine” using the speech synthesizer 30a for Korean, and is outputted by the multilingual processing apparatus 1000, and the user may receive the response to “How's the weather?” that he or she inquired.

If the user of the multilingual processing apparatus 1000 inquires “How's the weather?” in English, the same process is repeated while passing through a speech recognizer 10b for English, a natural language processing module 20b for English, and a speech synthesizer 30b for English.

That is, in the multilingual processing apparatus 1000 of FIG. 6, the speech recognizers, the natural language processing modules, and the speech synthesizers should be provided for each language to enable a response to the corresponding language.

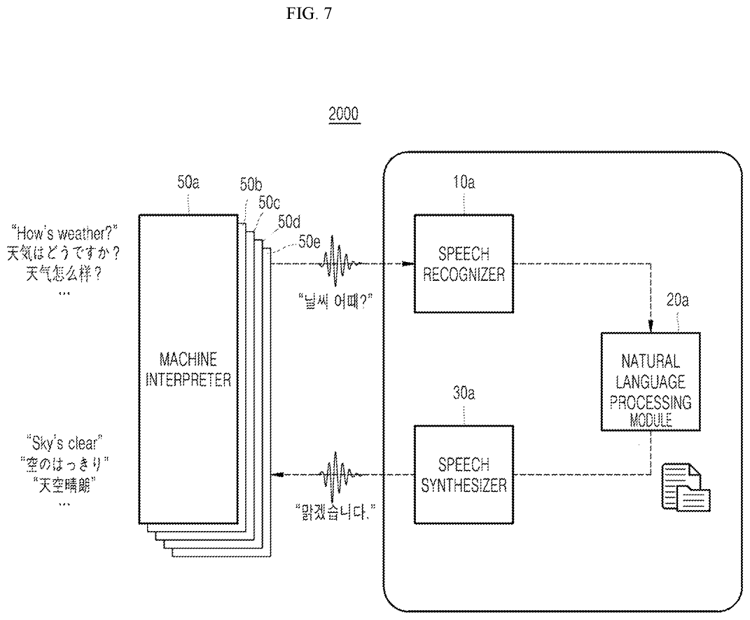

FIG. 7 is a diagram for describing an apparatus for performing multi-language communication according to an embodiment of the present disclosure.

Unlike the multilingual processing apparatus 1000 of FIG. 6, an apparatus 2000 for performing multi-language communication of FIG. 7 is a speech recognizer 10a, a natural language processing module 20a, and a speech synthesizer 30a for a reference language which is one language, and may further include machine interpreters 50a, 50b, 50c, 50d, and 50e. Here, it is assumed that the reference language of the apparatus 2000 for performing multi-language communication is Korean.

If the apparatus 2000 for performing multi-language communication receives an utterer's voice inquiry of “How's the weather?” in English, the apparatus 2000 for performing multi-language communication first determines that the language of the utterance is English, and converts the utterance into “How's the weather?” in Korean, using an English-to-Korean machine interpreter 50a.

The converted Korean speech of “How's the weather?” is changed to Korean text of “How's the weather?” by the speech recognizer 10a, and the meaning thereof is analyzed by the natural language processing module 20a so as to generate a response of “It's fine” in Korean.

Here, the natural language processing module 20a used may be an artificial intelligence-based natural language processing module, and various methods such as Natural Language Toolkit, spaCy, OpenNLP, Retext, and CogCompNLP may be used.

The Korean text of “It's fine” may be converted into Korean speech of “It's fine” by the speech synthesizer 30a, and the Korean speech may be converted into “It's fine” in English by a Korean-to-English machine interpreter.

Meanwhile, the apparatus 2000 for performing multi-language communication may further perform a process of identifying the language of the received utterance and then determining whether the identified language matches a preset reference language (for example, Korean), and in the above processes, a process of a machine interpreter involved can be omitted if the inputted language is Korean, which is the reference language.

By using the machine interpreter at the beginning and end of the process as described above, an apparatus for enabling multi-language communication including only a speech recognizer, a natural language processing module, and a speech synthesizer which are generated for one language can be provided.

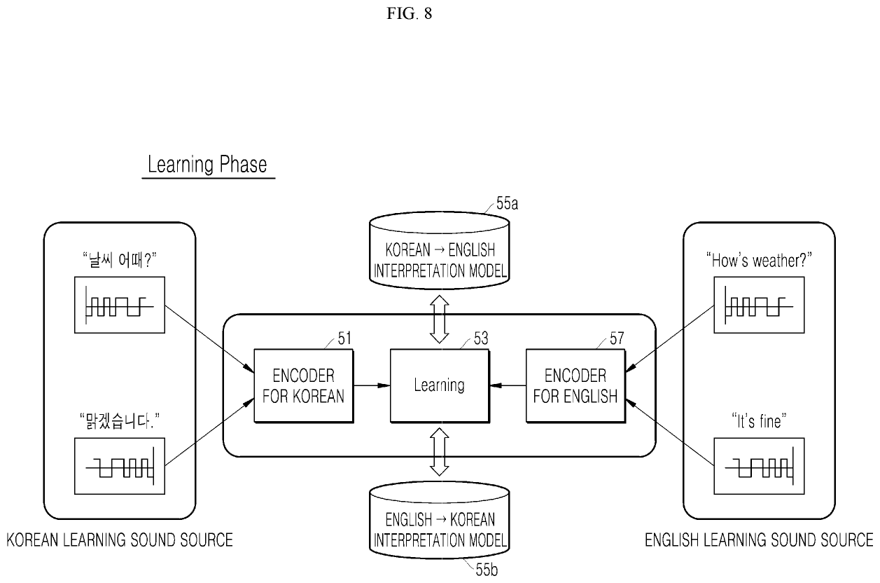

FIG. 8 is a diagram for describing a process for creating a neural network model for multilingual speech interpretation according to an embodiment of the present disclosure.

FIG. 8 shows a process performed in a learning step for creating an interpretation model between languages, and shows a case of supervised learning.

When the initial neural network model is built, the developers can prepare training data in which corresponding Korean and English expressions are paired with each other, such as (“Nalssiga eottae?” (Korean), “How's the weather” (English)), and (“Makgetseumnida” (Korean), “It's fine” (English)).

As a result, when “How's the weather?” in Korean is inputted to an encoder 51 for Korean and “How's the weather?” in English is inputted to an encoder 57 for English, data outputted through the encoders are inputted to a learning module 53, and thus a Korean-to-English interpretation model 55a and an English-to-Korean interpretation model 55b are generated.

In order to create useful interpretation models, a large amount of training data is required, and if supervised learning is performed in the above manner, a Korean-to-English interpretation model and an English-to-Korean interpretation model that can be used in the apparatus 2000 for performing multi-language communication according to the embodiment of the present disclosure are created.

In the above manner, if the learning sound source is Korean and Japanese, a Korean-to-Japanese interpretation model and a Japanese-to-Korean interpretation model may be created, and if the learning sound source is Korean and Chinese, a Korean-to-Chinese interpretation model and a Chinese-to-Korean interpretation model may be created.

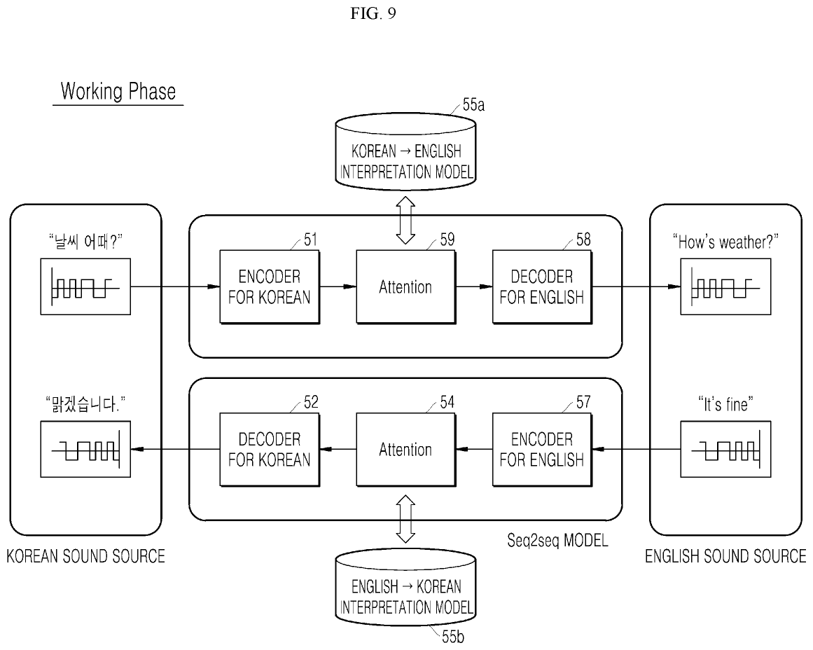

FIG. 9 is a diagram for describing a process for applying a neural network model created for multilingual speech interpretation according to an embodiment of the present disclosure.

FIG. 9 shows a process in which the interpretation model created in FIG. 8 is used in an application step, in which a process performed in a machine interpreter is described and the reference language shown in the example of FIG. 9 is set as English. In addition, in the example of FIG. 9, a method of a translator of a seq2seq model is described as an example.

In a state in which the completed Korean-to-English interpretation model 55a is prepared, if speech of “How's the weather?” in Korean is inputted, the encoder for Korean can vectorize the received speech, and examples of the encoder that can be used include voice2vec and word2vec.

The vectorized speech is interpreted into a target language using an attention model 59 and the Korean-to-English interpretation neural network model 55a, and is outputted as speech of “How's the weather?” in English, through a decoder 58 for English.

In addition, as shown in FIG. 7, when a spoken response of “It's fine” is generated through natural language processing and speech synthesis, the spoken response is inputted to the encoder 57 for English and subjected to vectorization, and is interpreted into a target language through the attention model 59 and the English-to-Korean interpretation neural network model 55b, and outputted as speech of “It's fine” in Korean, through a decoder 52 for Korean.

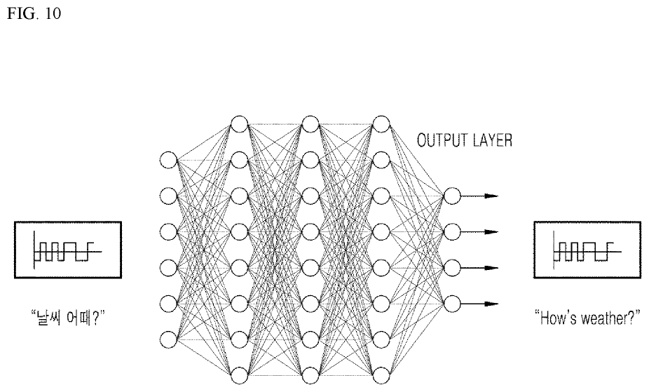

FIG. 10 is a diagram for describing a neural network model created for multilingual speech interpretation according to an embodiment of the present disclosure.

FIG. 10 exemplarily shows a structure of an interpretation neural network model trained through the learning step in FIG. 8, and if Korean speech of “How's the weather?” is inputted to the completely trained Korean-to-English interpretation neural network model, English speech of “How's the weather?” may be outputted.

The neural network may be configured to include an input layer, a hidden layer, and an output layer. The number of input nodes is determined according to the number of features, and as the number of nodes increases, the complexity or dimensionality of the neural network increases. In addition, as the number of hidden layers increases, the complexity or dimensionality of the neural network increases.

The number of features, the number of input nodes, the number of hidden layers, and the number of nodes in each layer may be determined by the designer of the neural network, and as the complexity increases, the processing time takes longer but the performance may be better.

Once the initial neural network structure is designed, the neural network may be trained with training data. In order to implement the neural network for Korean-to-English interpretation, a Korean learning sound source and an English learning sound source corresponding thereto are required.

If Korean speech is inputted, a trained model trained with training data including a plurality of Korean learning sound sources and a plurality of English learning sound sources corresponding thereto as labels may provide English speech corresponding to the inputted Korean speech.

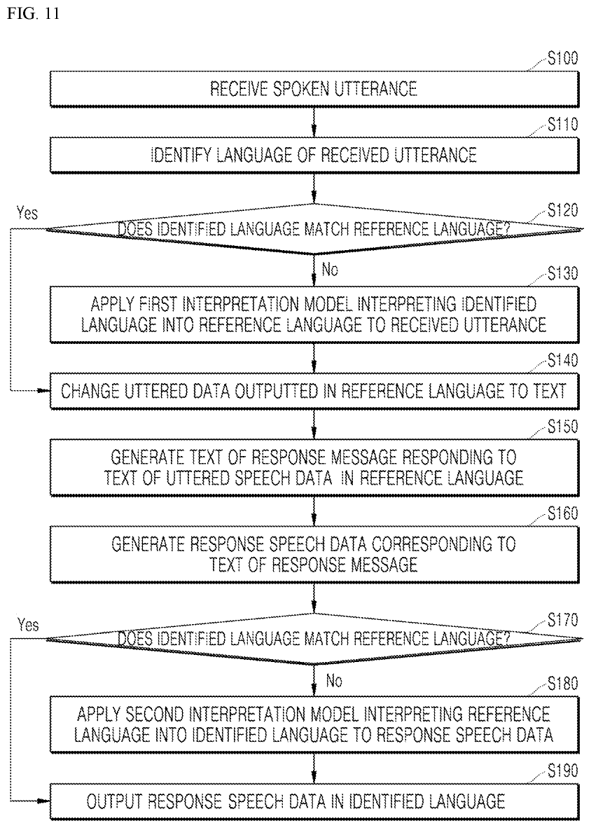

FIG. 11 shows a flowchart of a method of performing multi-language communication according to an embodiment of the present disclosure.

In the example of FIG. 11, it is assumed that the reference language is set to Korean, and although various languages may be inputted, it is assumed that English is inputted.

The apparatus 100 for performing multi-language communication may receive a spoken utterance from an utterer through a microphone (S100). For example, the utterer may utter “How's the weather?” to the apparatus 100 for performing multi-language communication.

The apparatus 100 for performing multi-language communication may identify in which language the received utterance of “How's the weather?” is uttered (S110). Such identification may be made based on characteristics of each language such as the characteristics of speech frequencies for each language and characteristics of pronunciation, and for example, Apache OpenNLP, Apache Tika, and the like may be used. However, the present disclosure is not limited thereto, and other machine learning-based programs may be used to identify the language of the received utterance.

The processor of the apparatus 100 for performing multi-language communication may determine that English, which is the identified language, does not match Korean, which is the reference language (S120), and may thus apply, to the received utterance, an English-to-Korean interpretation model for interpreting English into Korean (S130).

If “How's the weather” in English is inputted to the pre-trained English-to-Korean interpretation model, speech of “How's the weather?” in Korean is outputted, and the processor may convert the speech data outputted in Korean into text (S140).

The text conversion of the speech data may be performed using an STT algorithm. The processor may grasp the meaning of the text inputted in Korean using the natural language processing model for Korean, and generate the text of the response message “It's fine” in Korean (S150).

Here, the natural language processing may be performed within the apparatus 100 for performing multi-language communication, and the apparatus 100 for performing multi-language communication may transmit text to an external server for natural language processing with greater processing capability. The external server may perform the natural language processing to generate the text of the response message, and then transmit the generated text to the apparatus 100 for performing multi-language communication.

The processor may generate response speech data corresponding to the Korean text of “It's fine” (S160). For example, the Korean text “It's fine” may be converted into Korean speech of “It's fine” via the TTS algorithm.

Since the language received from the utterer is English and the reference language is Korean, since the language identified in the initial stage does not match the reference language, interpretation is required (S170).

Therefore, “It's fine” in Korean is inputted to the pre-trained Korean-to-English interpretation model (S180), and the English response speech of “It's fine” is outputted (S190).

Meanwhile, the apparatus 100 for performing multi-language communication may pass through a process of setting a suitable reference language before the utterance is received, or before the apparatus is placed in the use environment.

The processor of the apparatus 100 for performing multi-language communication may perform a step of acquiring information on the location where the apparatus is installed by using, for example, GPS and the like. In addition, the apparatus 100 for performing multi-language communication may receive demographic information of an area corresponding to a corresponding location by communicating with an external server through the communication interface 180.

For example, if the apparatus 100 for performing multi-language communication is installed in Ulaanbaatar in Mongolia, the apparatus 100 for performing multi-language communication may receive demographic information of Ulaanbaatar, and acquire information indicating that there are a large number of Mongolian speakers.

Based on this information, the processor of the apparatus 100 for performing multi-language communication may determine Mongolian as the most used language in the area.

The apparatus 100 for performing multi-language communication stores an interpretation model using Mongolian, and the processor may select Mongolian as the reference language if Mongolian is in the group of adoptable reference languages.

However, if the available interpretation neural network model includes English-to-Korean and Korean-to-English interpretation models but does not include English-to-Mongolian and Mongolian-to-English interpretation models, the apparatus 100 for performing multi-language communication may determine that Mongolian cannot be selected as the reference language. In this case, Korean-to-Mongolian and Mongolian-to-Korean interpretation models may exist.

In this case, as an alternative, a language belonging to the same language family as Mongolian, which is the most used language, may be selected as the reference language. Mongolian belongs to the Altaic language family, and Korean is also in the Altaic language family. Since there is an interpretation model using Korean, the processor of the apparatus 100 for performing multi-language communication may set Korean as the reference language instead of Mongolian.

Further, language families such as the Altaic language family, the Indo-European language family, and the Sino-Tibetan language family may exist as language families, and each language family may include languages having similar grammar or pronunciation rules. The interpretation models between similar language families may be more accurate, and the conversion process may be performed relatively simply.

In this manner, the apparatus 100 for performing multi-language communication according to the embodiment of the present disclosure may set, as the reference language, even a language without an interpretation model, and the accuracy and efficiency of speech processing can be increased thereby.

Embodiments according to the present disclosure described above may be implemented in the form of a computer program that can be executed through various components on a computer, and such a computer program may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The order of individual steps in process claims according to the present disclosure does not imply that the steps must be performed in this order; rather, the steps may be performed in any suitable order, unless expressly indicated otherwise. The present disclosure is not necessarily limited to the order of operations given in the description. All examples described herein or the terms indicative thereof (“for example,” “such as”) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations can be made depending on design conditions and factors within the scope of the appended claims or equivalents thereof.

It should be apparent to those skilled in the art that various substitutions, changes and modifications which are not exemplified herein but are still within the spirit and scope of the present disclosure may be made.

What is claimed is:

1. A method for performing multi-language communication, the method comprising:
receiving an utterance;
identifying a language of the received utterance;
determining whether the identified language matches a preset reference language;
applying, to the received utterance, a first interpretation model interpreting the identified language into the reference language when the identified language does not match the reference language;
changing first speech data, which is outputted in the reference language as a result of applying the first interpretation model, to text;
generating a response message responding to the text of the first speech data; and
outputting the response message.

2. The method of claim 1, wherein the generating of a response message comprises:
generating, in the reference language, text of the response message responding to the text of the first speech data; and
generating second speech data corresponding to the text of the response message.

3. The method of claim 2, wherein the outputting of the response message comprises:
applying, to the second speech data, a second interpretation model interpreting the reference language into the identified language; and
outputting third speech data, which is outputted in the identified language as a result of applying the second interpretation model.

4. The method of claim 1, wherein the first interpretation model is a neural network model which is trained using training data including speech data uttered in the identified language that is labelled with corresponding speech data uttered in the reference language.

5. The method of claim 3, wherein the second interpretation model is a neural network model which is trained using training data including speech data uttered in the reference language that is labelled with corresponding speech data uttered in the identified language.

6. The method of claim 1, wherein the changing the first speech data to text comprises converting the first speech data into text using a speech to text (STT) algorithm for the reference language.

7. The method of claim 2, wherein the generating the second speech data comprises converting the text of the response message into the second speech data using a text to speech (TTS) algorithm for the reference language.

8. The method of claim 1, further comprising:
prior to the receiving the utterance,
acquiring information on a location where the utterance is to be received;
receiving demographic information of an area corresponding to the location information; and
determining a most used language based on the demographic information.

9. The method of claim 8, further comprising:
after the determining of the most used language,
determining whether the most used language exists in a group of adoptable reference languages; and
setting the most used language as the reference language when the most used language exists in the group of adoptable reference languages, and setting, as the reference language, a language belonging to the same language family as the most used language among the languages existing in the group of adoptable reference languages when the most used language does not exist in the group of adoptable reference languages.

10. The method of claim 1,
further comprising photographing an utterer of the utterance, and
wherein the identifying the language of the received utterance comprises:
determining candidate languages used by the utterer based on an image analysis of the utterer;
analyzing the language of the received utterance based on the candidate languages; and
determining the language of the received utterance based on the analysis.

11. The method of claim 10, wherein the outputting of the response message comprises:
determining a voice to transmit the response message according to a gender or an age of the utterer obtained by the image analysis of the utterer; and
outputting the response message in the determined voice.

12. An apparatus configured to perform multi-language communication, the apparatus comprising:
a microphone configured to receive an utterance;
a memory configured to store an instruction; and
one or more processors configured to be connected to the microphone and the memory,
wherein the one or more processors are configured to:
identify a language of the utterance received from the microphone;
determine whether the identified language matches a preset reference language;
apply, to the received utterance, a first interpretation model interpreting the identified language into the reference language when the identified language does not match the reference language;
change first speech data, which is outputted in the reference language as a result of applying the first interpretation model, to text; and
generate a response message responding to the text of the first speech data.

13. The apparatus of claim 12, wherein the one or more processors are further configured to:
generate, in the reference language, text of the response message responding to the text of the first speech data; and
generate second speech data corresponding to the text of the response message.

14. The apparatus of claim 13, wherein the one or more processors are further configured to apply, to the second speech data, a second interpretation model interpreting the reference language into the identified language; and
output third speech data, which is outputted in the identified language as a result of applying the second interpretation model.

15. The apparatus of claim 14, wherein
the memory is configured to store the first interpretation model and the second interpretation model,
the first interpretation model is a neural network model which is trained using training data including speech data uttered in the identified language that is labelled with corresponding speech data uttered in the reference language, and
the second interpretation model is a neural network model which is trained using training data including speech data uttered in the reference language that is labelled with corresponding speech data uttered in the identified language.

16. The apparatus of claim 12, wherein the one or more processors are further configured to:
acquire information on a location where the apparatus is installed;
receive demographic information of an area corresponding to the location information; and
determine a most used language based on the demographic information.

17. The apparatus of claim 16, wherein after determining a most used language, the one or more processors are further configured to:
determine whether the most used language exists in a group of adoptable reference languages; and
set the most used language as the reference language when the most used language exists in the group of adoptable reference languages, and set, as the reference language, a language belonging to the same language family as the most used language among the languages existing in the group of adoptable reference languages when the most used language does not exist in the group of adoptable reference languages.

18. The apparatus of claim 12,
further comprising a camera configured to photograph an utterer of the utterance, and
wherein the one or more processors are configured to:
determine candidate languages to be used by the utterer based on an image analysis of the utterer photographed by the camera;
analyze the language of the received utterance based on the candidate languages; and
determine the language of the received utterance based on the analysis.

19. The apparatus of claim 18, wherein the one or more processors are configured to determine a voice to transmit the response message according to a gender or an age of the utterer obtained by the image analysis of the utterer photographed by the camera, and output the response message in the determined voice.

20. A computer readable recording medium storing a computer program configured to perform multi-language communication,
wherein the computer program, when executed by a processor, is configured to cause the processor to:
receive an utterance;
identify a language of the received utterance;
determine whether the identified language matches a preset reference language;
apply, to the received utterance, a first interpretation model interpreting the identified language into the reference language when the identified language does not match the reference language;
change first speech data, which is outputted in the reference language as a result of applying the first interpretation model, to text; and
generate a response message responding to the text of the first speech data.
